(19) United States
(12) Patent Application Publication
(10) Pub. No.: US 2013/0187908 A1
(43) Pub. Date: Jul. 25, 2013

(54) IMAGE PROCESSING DEVICE AND METHOD THEREOF

(71) Applicant: REALTEK SEMICONDUCTOR CORP., Hsinchu (TW)

(72) Inventors: Chia-Wei Yu, Taipei City (TW); Hui-Hung Lin, Kaohsiung City (TW); Hsu-Jung Tung, Hsinchu County (TW)

(73) Assignee: REALTEK SEMICONDUCTOR CORP., Hsinchu (TW)

(21) Appl. No.: 13/745,887

(22) Filed: Jan. 21, 2013

(30) Foreign Application Priority Data
Jan. 20, 2012 (TW) 101102414

(51) Int. Cl. G06T 15/00

(52) U.S. Cl. CPC G06T 15/00
USPC 345/419

(57) ABSTRACT

An image processing device and method is disclosed. The image processing device includes a depth-of-interest (DOI) determining circuit and an image processing circuit. The DOI determining circuit generates a DOI distribution of the input image and corresponding depth information of the input image. The image processing circuit receives the input image and performs a predetermined image processing operation on the input image according to the DOI distribution to generate an output image.

### CROSS-REFERENCE TO RELATED APPLICATION

The application claims the priority benefit of Taiwan application Ser. No. 101102414, filed Jan. 20, 2012, the full disclosure of which is incorporated herein by reference.

### FIELD OF THE INVENTION

The present disclosure relates to an image processing device and method, and more particularly, to an image processing device and method for performing image processing according to depth information.

### BACKGROUND OF THE INVENTION

3D (3-dimension) displays have recently become more and more popular, but many source images are still 2D (2-dimension) images. Thus, there is a need for converting 2D image signals into 3D image signals.

In general, a process of converting 2D image signals into 3D image signals starts by computing depth information of the 2D image signals and then generating the 3D image signals containing left video Lv and right video Rv. However, no signal processing is performed on the 2D image signals by means of the depth information. Moreover, the conventional 2D image signals do not contain any depth information, and thus it is impossible to perform any signal processing on the 2D image signals in accordance with the depth information.

### SUMMARY OF THE INVENTION

An object of various embodiments is to provide an image processing device and method for adjusting the display effects in parts of an image or the whole image by means of depth information of the image.

Another object of various embodiments is to provide an image processing device and method for performing image processing on a key image region according to depth information of an image to improve the display effects of the image.

According to one embodiment of the invention, an image processing device includes a depth-of-interest (DOI) determining circuit and an image processing circuit. The DOI determining circuit receives an input image and corresponding depth information of the input image to generate a DOI distribution of the input image. The image processing circuit receives the input image to generate an output image by performing a predetermined image processing operation on the input image according to the DOI distribution.

According to another embodiment of the invention, an image processing device includes a depth estimation circuit, a DOI determining circuit and an image processing circuit. The depth estimation circuit receives and analyzes an input image to generate corresponding depth information of the input image. The DOI determining circuit receives the input image and the corresponding depth information of the input image and analyzes the input image to generate a DOI distribution of the input image. The image processing circuit receives the input image to generate an output image by performing predetermined image processing on the input image according to the DOI distribution.

According to another embodiment of the invention, an image processing method includes receiving an input image and corresponding depth information of the input image; analyzing the input image and the depth information to generate the DOI distribution of the input image; and generating an output image by performing image processing related to an image characteristic on the input image according to the DOI distribution.

The image processing device and method of the invention obtains the DOI distribution of an image by using the depth information and characteristics of the image, and then enhances at least one image characteristic of the regions with depth values close to the DOI distribution to thereby increase the image display quality.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 shows a schematic diagram of an image processing device according to one embodiment of the invention.

FIG. 2A shows a schematic diagram showing a frame processing of the image processing device of FIG. 1.

FIG. 2B shows a schematic diagram showing another frame processing of the image processing device of FIG. 1.

FIG. 3A shows a schematic diagram of an image processing device according to another embodiment of the invention.

FIG. 3B shows a schematic diagram showing a depth setting of the image processing device of FIG. 3A.

FIG. 4 shows a schematic diagram of an image processing device according to another embodiment of the invention.

FIG. 5 shows a schematic diagram of an image processing device according to another embodiment of the invention.

FIG. 6 shows a schematic diagram of an image processing device according to another embodiment of the invention.

FIG. 7 shows a schematic diagram of an image processing device according to another embodiment of the invention.

FIG. 8 shows a flow chart of an image processing method according to one embodiment of the invention.

### DETAILED DESCRIPTION OF THE INVENTION

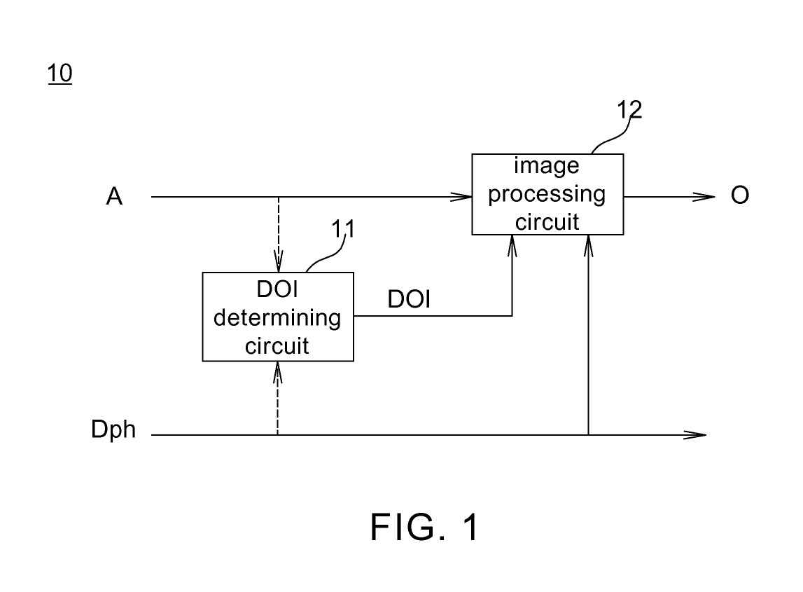

FIG. 1 shows a schematic diagram of an image processing device 10 according to one embodiment of the invention. The image processing device 10 includes a depth-of-interest (DOI) determining circuit 11 and an image processing circuit 12. The DOI determining circuit 11 receives an input image A and its corresponding depth information Dph of the input image A. The DOI determining circuit 11 analyzes the input image A and then obtains a depth distribution of a key image region, hereinafter referred to as “DOI distribution”. It is noted that the key image region may be determined by image characteristics or user-defined functions. For example, the key image region may comprise a human face, a specific position in the image (such as the center of the image, the lower half part of the image, and so on), or a position with a significant color difference between an object and its background. For example, when the DOI determining circuit 11 receives and analyzes the input image A to determine that the image A has a human face characteristic, the key image region is the human face region. As another example, after receiving and analyzing the input image A to determine that the image A has two main colors (such as several sunshade areas on a white sandy beach, there are at least two different colors for the white sandy beach and the sunshade areas), the DOI determining circuit 11 can determine that the sunshade areas are the key image region in the input image A. As another example, during a film shoot, a main object is usually close to the center of a frame; therefore, the DOI determining circuit 11 may regard the object located nearby the center of the frame as the key image region of the image A.

Following that, the image processing circuit 12 receives the image A, performs a predetermined image processing operation on the image A according to the DOI distribution and generates an output image 0.

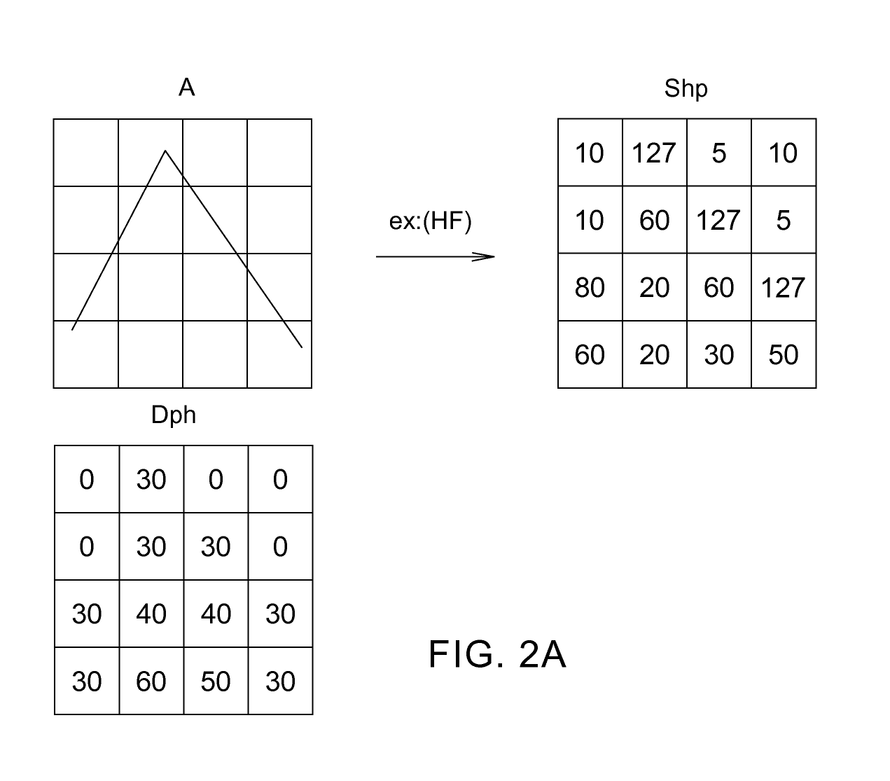

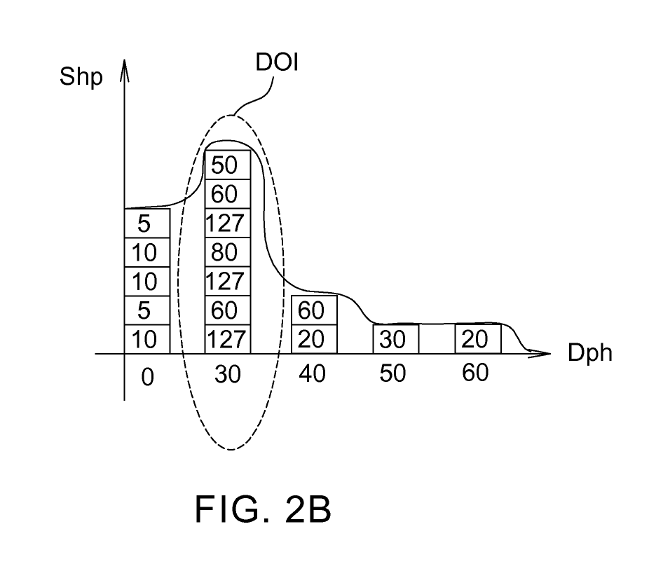

The DOI determining circuit 11 determines the key image region according to the distribution of one image characteristic of the image pixels, and outputs the DOI distribution according to the key image region and the depth information Dph of the image. As shown in FIG. 2A, the DOI determining circuit 11 receives the image A in the top-left corner and its corresponding depth information Dph in the bottom-left corner, and then analyzes the image A to obtain the DOI distribution of the image A. In this embodiment, there is a mountain in the image A. The DOI determining circuit 11 determines the key image region and thus obtains corresponding depth distribution of the mountain, i.e., the distribution of a depth value of 30 or the distribution of the depth values ranging from 30 to 60.

Referring now to FIGS. 2A and 2B, assume that the image processing related to sharpness is performed. First, after performing high-pass filtering on the image A, a image processing unit (not shown) of the DOI determining circuit 11 generates an image sharpness distribution diagram Shp as shown in the top-right corner of FIG. 2A. Next, the DOI determining circuit 11 statistically analyzes the relation between the depth information versus the corresponding sharpness values for the image A to generate a depth-sharpness statistical bar chart, as shown in FIG. 2B. Then, the image processing circuit 12 performs the sharpness processing on the image A according to the DOI distribution. A detailed description is now described.

In the depth diagram of FIG. 2A, starting from the leftmost pixel in the topmost row, a depth value of 0 corresponds to a sharpness value of 10, a depth value of 30 corresponds to a sharpness value of 127, a depth value of 0 corresponds to a sharpness value of 5 and a depth value of 0 corresponds to a sharpness value of 10. For the second row, a depth value of 0 corresponds to a sharpness value of 10, a depth value of 30 corresponds to a sharpness value of 60 and so on. In this manner, a statistical result is produced as shown in FIG. 2B. It is clear that the depth value of 30 in the image A has the maximum accumulated sharpness values. Accordingly, the DOI determining circuit 11 regards this region (with a depth value of 30) as the interest (key) of the image (i.e., the key image region), and other regions with depth values other than 30 as non-key image regions. Therefore, the DOI distribution is determined according to a region with the maximum accumulated sharpness values. The image processing circuit 12 then receives the image A and performs image processing related to one image characteristic (such as sharpness) on the image A according to the DOI distribution, i.e., enhancing the sharpness of the pixels in the key image region of the image A and reducing the sharpness of the other pixels outside the key image region of the image A. Note that the adjustment may be varied according to user settings. Based on the adjustment described in the above embodiment, the image processing device 10 makes the key image region sharper to enhance the key image region of the image A, thereby achieving a better image output quality and an improved the display effect.

The sharpness adjustment (one of the above-mentioned image characteristics) is merely provided by way of example and not limitation of various embodiments of the invention. After obtaining the DOI distribution of the image A, the image processing related to other image characteristics, such as sharpness, hue, saturation, intensity, depth information, and their combination, can be performed on the pixels of the key image region. Certainly, the above-mentioned image characteristics are merely examples, and not limitations of the invention. It should be understood, however, that the invention is not limited to these particular image processing characteristics described above, but may be fully extensible to any existing or yet-to-be developed image processing characteristics.

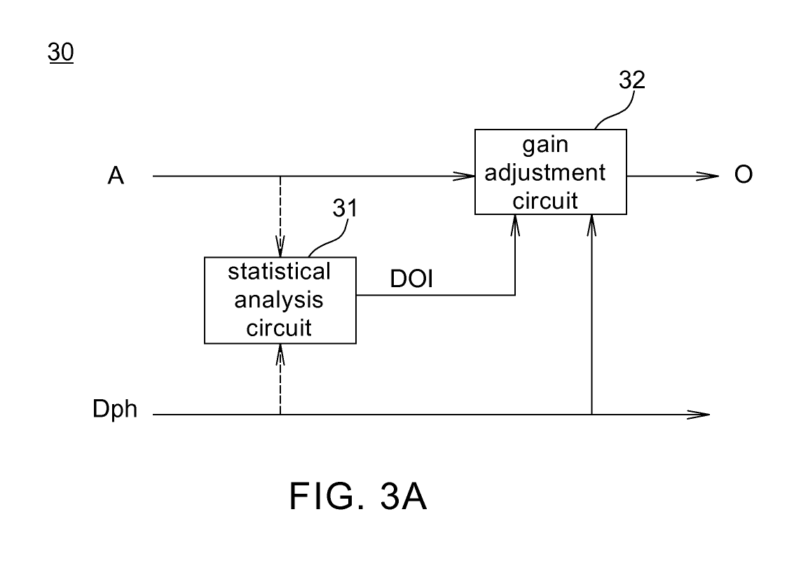

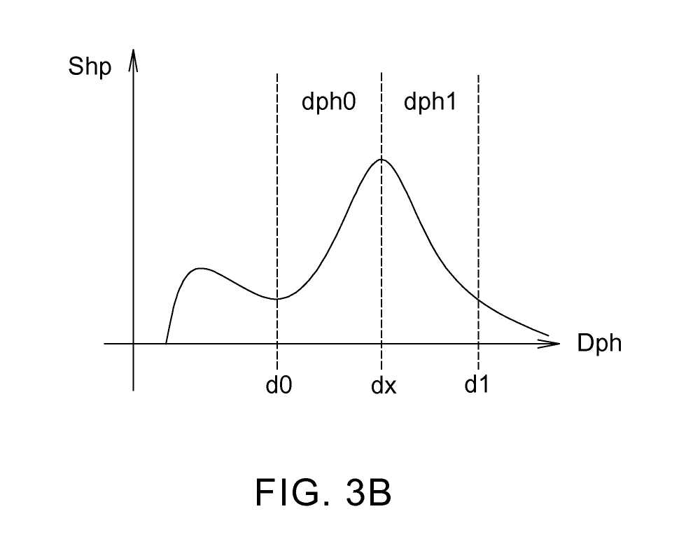

FIG. 3A shows a schematic diagram of an image processing device according to one embodiment of the invention. The image processing device 30 includes a statistical analysis circuit 31 and a gain adjustment circuit 32. For example, if sharpness is applied, the statistical analysis circuit 31 can be a sharpness statistical circuit and the gain adjustment circuit 32 can be a sharpness adjustment unit. By this way, the gain range can be adjusted based on the image characteristic corresponding to depth values, and the gain range can be arbitrarily set according to different needs.

Referring to FIG. 3B, in one embodiment, after the statistical analysis circuit 31 generates the DOI distribution, the gain adjustment circuit 32 can arbitrarily select at least one region from a plurality of regions with depth values close to the DOI distribution to enhance the sharpness of the at least one region. Assume that regions with depth values ranging from d0 to d1 are to be enhanced, the DOI is dx, and the gain value is g. When a target depth dph0 is less than dx and falls within the range of dx to d0, a difference between the target depth dph0 and a first threshold depth value d0 is multiplied by a positive gain value c0 to obtain the gain value g.

g=(dph0−d0)*c0, d0<dph0<dx (1)

When a target depth dph1 is greater than or equal to dx and falls within the range of dx to d1, a difference between a second threshold depth value d1 and the target depth dph1 is multiplied by a positive gain value c1 to obtain the gain value g.

g=(d1−dph1)*c1, d1>dph1>=dx (2)

In this manner, positive gain values can be obtained for the target depth values in the range of d0 to d1 to achieve the effect of the sharpness enhancement, and the maximum sharpness is achieved when the target depth is dx. Besides, the gain value g is set to a negative value to cause the pixels of the regions with the depth values outside the range of d0 to d1 to have less sharpness. In contrast, the display effects of the pixels of the regions with the depth values close to the DOI distribution are enhanced.

Referring to FIG. 3B, in another embodiment, the image processing device can assign a gain value to each region of the distribution of an image characteristic. For example:

g=g1, g1<0, when a depth value<d0 (3)

g=g2, g2<0, when a depth value>d1 (4)

g=g0, g 0>0, for the other regions (5)

where g is a gain value.

As shown in the above equations, sharpening processing can be performed on the regions with depth values in the range of d0˜d1, and de-sharpening (softening) processing is performed the regions with depth values outside the range of d0 to d1. Therefore, the display effects of the corresponding pixels of regions with depths close to the DOI distribution can also be enhanced.

The above-mentioned embodiments are merely illustrative examples, which can be used separately or in combination, and are not limitations of the invention. The invention is not limited to the particular methods described above, but may be fully extensible to any existing or yet-to-be developed methods.

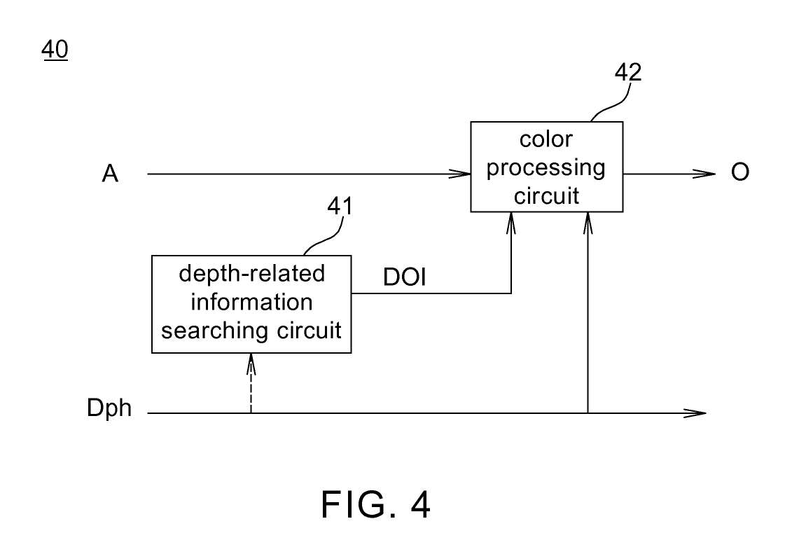

FIG. 4 shows a schematic diagram of an image processing device 40 according to another embodiment of the invention. The image processing device 40 includes a depth-related information searching circuit 41 and a color processing circuit 42. The depth-related information searching circuit 41 outputs the DOI distribution according to depth-related information such as a maximum value, a minimum value, an average value, or values of a key image region in a depth map. Next, the DOI distribution is sent to the color processing circuit 42. The color processing circuit 42 performs color adjustment, such as hue adjustment, chrominance adjustment or saturation adjustment, on the pixels of the image A according to the DOI distribution. Certainly, embodiments of the invention are not limited to the above-mentioned examples. The depth map is well known to those skilled in the art; therefore, the description is omitted. The detailed description can be obtained easily, such as by searching on the internet.

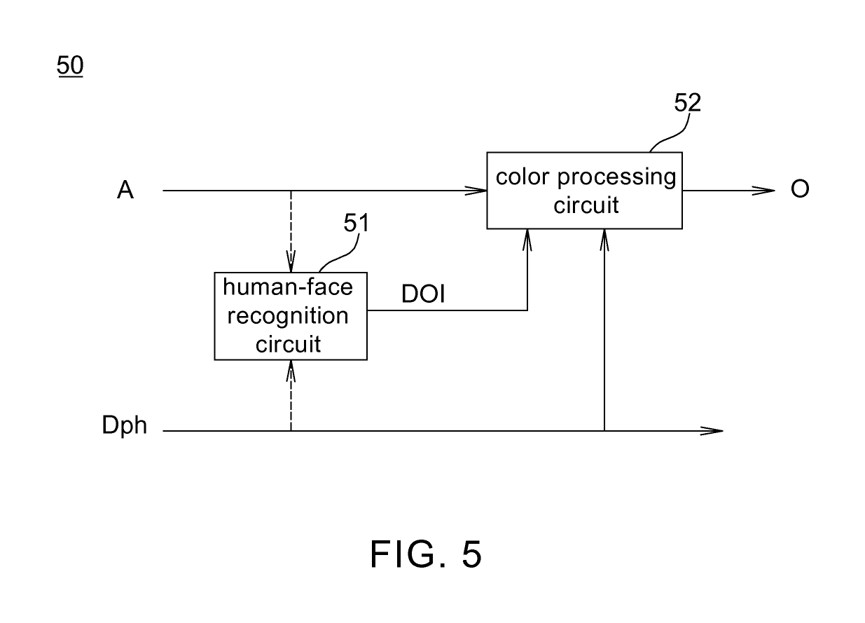

Hereinafter, the maximum value of the depth map is taken as an example for description. The depth-related information searching circuit 41 fetches the maximum depth value from the depth map of the image A as the depth-related information to generate the DOI distribution. Note that the magnitudes of the depth values of the depth map are proportional to distances. In an alternative embodiment, the depth-related information searching circuit 41 may fetch the minimum depth value from the depth map of the image A as the depth-related information to generate the DOI distribution. Further the depth-related information searching circuit 41 may fail to find the maximum value of the depth map. When this occurs, the depth-related information is directly set to a predetermined maximum value. For example, if the depth value is represented by 8 bits in binary format, then 0xFF (the maximum value of 8 bits in binary format) is taken as the DOI distribution. Then, according to the DOI distribution, the color processing circuit 42 performs saturation enhancement on the pixels of the regions in connection with the DOI distribution in the image A and reduces the saturation of the pixels of the regions without connection to the DOI distribution. FIG. 5 shows a schematic diagram of an image processing device 50 according to another embodiment of the invention. The image processing device 50 includes a human-face recognition circuit 51 and a color processing circuit 52. In the embodiment, the human-face recognition circuit 51 searches depths of a human face in an image, and then generates the DOI distribution. Please be noted that the human-face recognition circuit 51 can be configured to search depths of other predetermined objects as the key image region to generate the DOI distribution. Then, the color processing circuit 52 can perform at least one type of image processing. For example, image processing related to sharpness and saturation enhancement is performed on the regions in connection with DOI distribution. Note that a source image of the image processing device of the embodiment of the invention can be a 2D image or a 3D image.

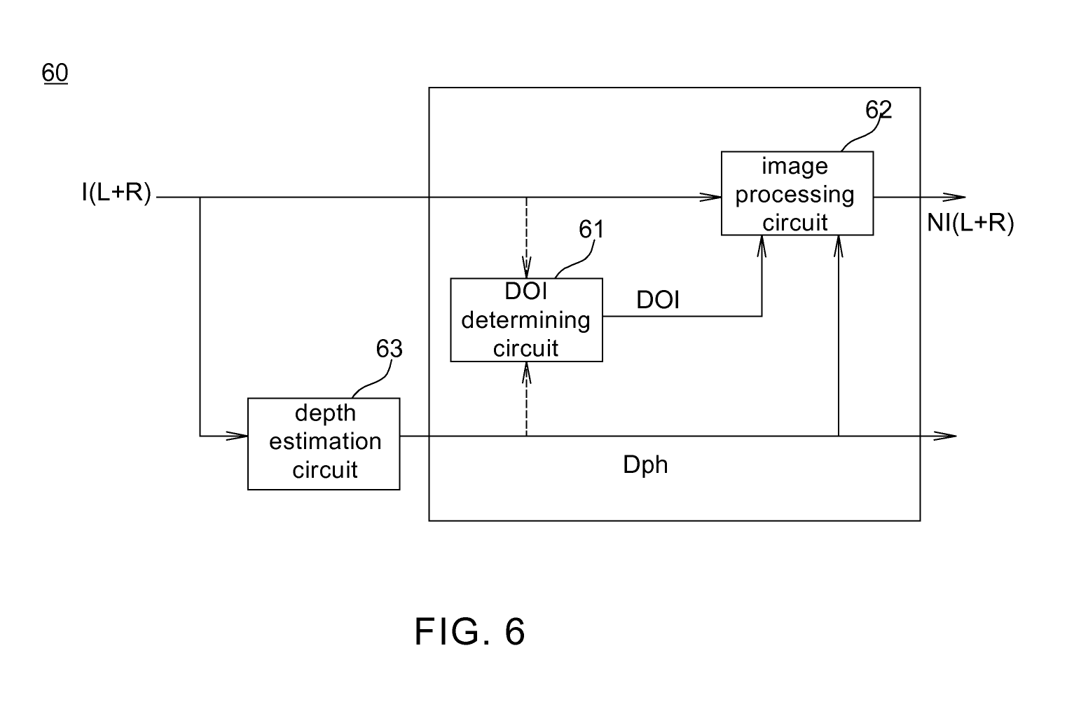

Referring to FIG. 6, in an image processing device 60 of an embodiment of the invention, when the source image is a 3D image I(L+R) containing left-eye and right-eye images, a depth estimation circuit 63 receives the 3D image I(L+R) to generate a depth map of the 3D image I(L+R) and then a DOI determining circuit 61 generates a DOI distribution. Finally, an image processing circuit 62 processes the 3D image I(L+R) to thereby enhance the image characteristics of the regions in connection with the DOI distribution.

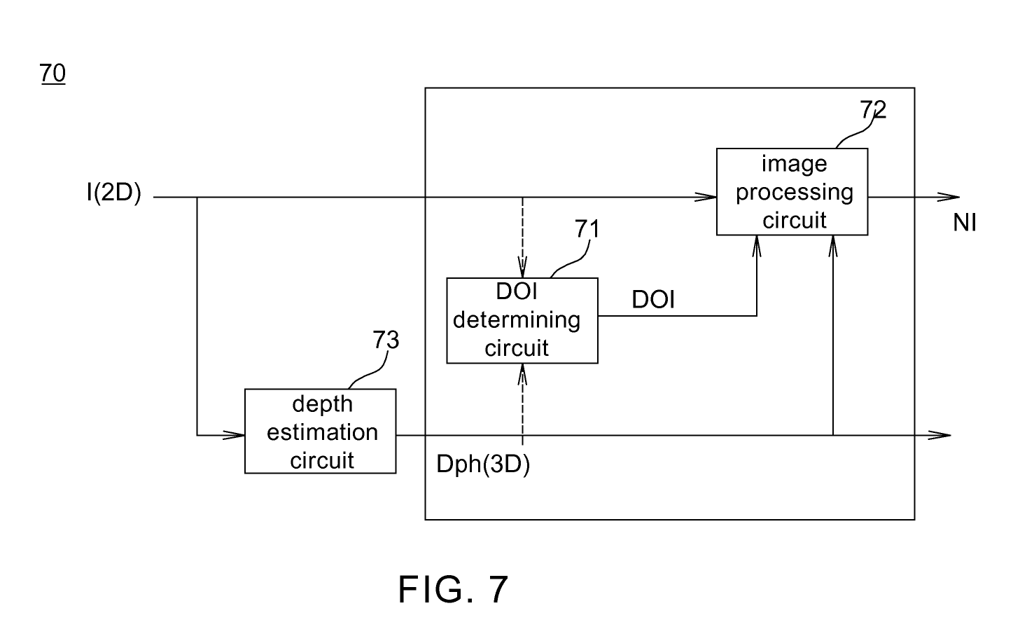

Referring to FIG. 7, in an image processing device 70 of an embodiment of the invention, when the source image is a 2D image, a depth estimation circuit 73 receives the 2D image I(2D) and estimates the depths of the 2D image I(2D) to generate a depth map Dph(3D). Then a DOI determining circuit 71 generates a DOI distribution according to the 2D image and the depth map Dph(3D). Finally, an image processing circuit 72 processes the 2D image I(2D) to thereby enhance the image characteristics of the regions in connection with the DOI distribution.

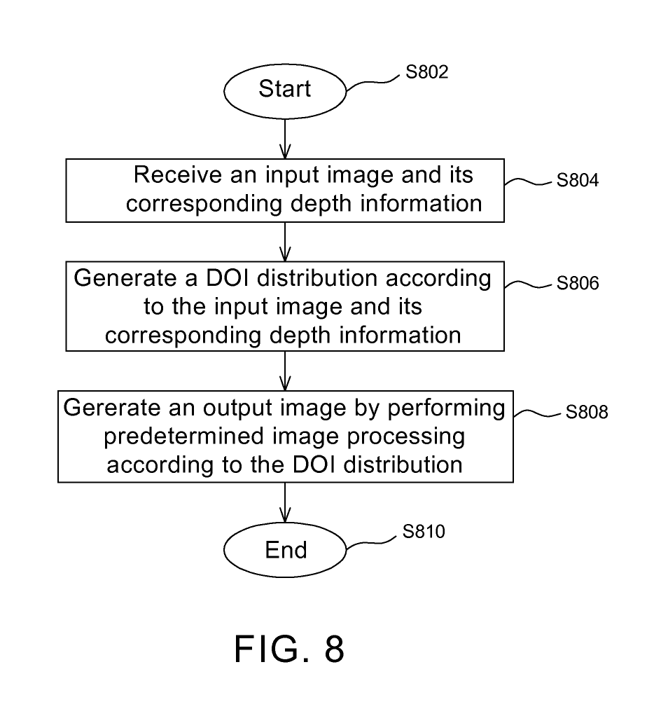

FIG. 8 shows a flow chart of an image processing method according to one embodiment of the invention. The method includes the steps as follows.

Step S802: Begin.

Step S804: Receive an input image and its corresponding depth information of the input image.

Step S806: Generate a DOI distribution of the input image according to the input image and the corresponding depth information.

Step S808: Generate an output image by performing a predetermined image processing operation on the input image according to the DOI distribution.

Step S810: End.

The image processing device and method of various embodiments of the invention appropriately enhance the image display effects, and thus achieves the goal of improving the image display quality.

While certain exemplary embodiments have been described and shown in the accompanying drawings, it is to be understood that such embodiments are merely illustrative of and not restrictive on the broad invention, and that this invention should not be limited to the specific construction and arrangement shown and described, since various other modifications may occur to those ordinarily skilled in the art.

What is claimed is:

1. An image processing device, comprising:
a depth-of-interest (DOI) determining circuit for receiving an input image and corresponding depth information of the input image and generating a DOI distribution of the input image; and
an image processing circuit for receiving the input image and performing a predetermined image processing operation on the input image according to the DOI distribution and generating an output image.

2. The device according to claim 1, wherein the DOI determining circuit generates adjusted characteristic distribution state data of the input image according to a distribution state of an image characteristic of the input image and the corresponding depth information of the input image, and then generates the DOI distribution according to the adjusted characteristic distribution state data.

3. The device according to claim 1, wherein the predetermined image processing operation comprises an adjustment of values of an image characteristic of pixels of the input image according to the DOI distribution.

4. The device according to claim 3, wherein the image characteristic comprises at least one of the following: sharpness, hue, saturation, brightness, and any combination thereof.

5. The device according to claim 1, wherein the DOI determining circuit is a statistical analysis circuit for analyzing a distribution state of an image characteristic versus the depth information for the input image.

6. The device according to claim 1, wherein the DOI determining circuit is a depth-related information searching circuit for analyzing the corresponding depth information to generate at least one of the following: a maximum depth value, a minimum value, an average value, a key region depth value, and any combination thereof.

7. The device according to claim 1, wherein the DOI determining circuit is a predetermined object recognition circuit for recognizing depth values of a predetermined object of the input image to generate the DOI distribution.

8. The device according to claim 7, wherein the predetermined object is a human face of the input image.

9. The device according to claim 1, wherein the image processing circuit is a gain adjustment circuit that selects at least one region from a plurality of regions with depth values close to the DOI distribution and performs an adjustment of an image characteristic on the at least one region.

10. The device according to claim 1, wherein the image processing circuit is a color processing circuit for performing a color adjustment on the input image according to the DOI distribution.

11. The device according to claim 10, wherein the color adjustment comprises at least one of the following: hue adjustment, chrominance adjustment, saturation adjustment, and any combination thereof.

12. An image processing device, comprising:
a depth estimation circuit for receiving an input image, and analyzing the input image to generate corresponding depth information of the input image;
a depth-of-interest (DOI) determining circuit for receiving the input image and the corresponding depth information of the input image, and analyzing the input image to generate a DOI distribution of the input image; and
an image processing circuit for receiving the input image, performing a predetermining image processing operation on the input image according to the DOI distribution to generate an output image.

13. The device according to claim 12, wherein the input image is a 2D image or a 3D image.

14. The device according to claim 12, wherein the DOI determining circuit generates adjusted characteristic distribution state data of the input image according to a distribution state of an image characteristic of the input image and the corresponding depth information of the input image, and then generates the DOI distribution according to the adjusted characteristic distribution state data.

15. The device according to claim 14, wherein the image characteristic comprises at least one of the following: sharpness, hue, saturation, brightness, and any combination thereof.

16. An image processing method, comprising:
receiving an input image and corresponding depth information of the input image;
analyzing the input image and the corresponding depth information to generate a DOI distribution of the input image; and
generating an output image by performing image processing related to an image characteristic on the input image according to the DOI distribution.

17. The method according to claim 16, wherein the image characteristic comprises at least one of the following: sharpness, hue, saturation, brightness, and any combination thereof.

18. The method according to claim 16, wherein the input image is a 2D image or a 3D image.

19. The method according to claim 18, further comprising:
wherein when the input image is a 2D image, generating the corresponding depth information by analyzing the 2D image.
